(19) United States
(12) Patent Application Publication
(10) Pub. No.: US 2005/0007660 A1
(43) Pub. Date: Jan. 13, 2005

(54) Optical microscope comprising a displaceable objective

(76) Inventor: Winfried Denk, Heidelberg (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/493,593

(22) PCT Filed: Oct. 25, 2002
(86) PCT No.: PCT/EP02/11937

(30) Foreign Application Priority Data
Oct. 25, 2001 (DE) 101 52 609.1

(51) Int. Cl. G02B 21/00

(52) U.S. Cl. 359/384; 359/368

(57) ABSTRACT

An imaging device for microscopic imaging of an object using an objective, which is set up for generating an object image in infinity, and a fixed tube optic, which is set up to generate an intermediate image from the object imaged, are described, the objective being situated so it is movable in relation to the tube optic in at least one reference direction, which deviates from the alignment of the optical axis of the objective, and a deflection device having at least one adjustable reflector, which directs the beam path from the objective onto the tube optic in any position of the objective in such a way that it runs perpendicularly to the tube optic and parallel to its optical axis, and an adjustment device are provided, using which the objective and the at least one reflector are movable.

The present invention relates to an imaging device for optical-microscopic imaging of an object, particularly an optical microscope having an adjustable objective, and a method for optical microscopy.

In optical microscopy, it is typically necessary to set the position of an object (sample) in relation to the microscope and particularly in relation to the objective of the microscope and possibly change the position in a predetermined way during the microscopic imaging or observation or between different imaging or observation steps. The mutual arrangement (relative position) must be adjustable in all three spatial directions. For some applications, there is the additional requirement of variation of the observation angle, i.e., the angle between the optical axis of the objective and the surface normal of the object, for example.

Until now, it has been typical to use an adjustable table having a drive for all three spatial directions to adjust the relative position. The object is situated on the adjustable table and positioned in relation to the fixed microscope. For many applications, however, it is undesirable or even impossible to move the object in relation to the microscope. Examples of this are the observation of heavy objects or objects which are immovable for another reason or the combination of microscopic imaging with other measurement or manipulation methods, such as the derivation of electrical potentials in neurophysiology.

The relative positioning of an object and the microscope is also possible through movement of the entire microscope construction for a fixed object. However, this method is restricted to a few special applications for the following reasons. Firstly, microscopes typically have a high weight, so that not every alignment in space is achievable without something further. Furthermore, there is frequently the necessity to align the microscope in relation to further stationary devices, such as lasers. For the reasons cited, until now, complex microscopic methods in particular, such as confocal or multiquanta microscopy, have been executable not at all or in only a limited way on fixed or stationary objects.

Microscopes are known in which the objective is displaced in relation to the remaining construction of the microscope for focusing, i.e., to set the objective on a focal plane in the object. This focusing movement along the optical axis of the objective is based on the following feature of most modern microscopes. Specifically, a microscope objective is typically laid out for an infinite image distance. This means that the imaged region of the object is imaged at infinity. An intermediate image of the object which may be observed using an ocular is generated using a tube lens. An advantage of this construction is particularly that the distance between the objective and the tube lens may be varied within specific limits for focusing without the imaging properties of the entire optical system, which are limited by the diffraction, being impaired. The conventional focusing movement of the objective is restricted to axial displacements, however. Free setting of the relative position between object and microscope in all spatial directions is therefore not possible.

The object of the present invention is to provide an improved imaging device for microscopic imaging of an object, using which the disadvantages of conventional microscopes are overcome and which particularly allows free setting of the relative coordinates between the objective and object without restriction of the imaging properties of the imaging device. It is also the object of the present invention to provide an improved imaging method for optical microscopy, using which free selection of the object region imaged is possible on stationary objects.

These objects are solved by an imaging device, a microscope, and a method having the features according to claims 1, 11, and 12. Advantageous embodiments and applications of the present invention result from the dependent claims.

The basic idea of the invention is to refine an imaging device for microscopic imaging of an object having an objective and a tube optic in such a way that the objective is positioned so it is movable in relation to the tube optic in at least one direction which deviates from the direction of the optical axis of the objective, and a deflection device for perpendicular and axially centered alignment of the beam path from the objective to the tube optic and an adjustment device for positioning the objective and for setting the deflection device are provided. The deflection and adjustment devices are operated in such a way that the optical axis of the objective and the optical axis of the tube optic deflected using the deflection device are coincident. Using an objective which is set up to generate the object image in infinity, this imaging device has the advantage that the objective may execute movements in relation to the tube optic and therefore in relation to the stationary microscope construction without the generation of an intermediate image being impaired. In particular, it is possible to execute translational and/or pivot movements using the objective. The mobility of the objective means that the position of the objective and/or the alignment of its optical axis is changeable between different operating states and may be set fixed in each new state.

Using the deflection device, which has at least one adjustable reflector according to the present invention, and the adjustment device, displacements of the beam path from the objective to the tube optic are compensated for in such a way that the beam path with the object image imaged at infinity is thus always incident on the tube optic in the same way as is the case for conventional microscopes having axially aligned optics. The translational movement means that the objective is movable according to the two spatial directions perpendicularly to the optical axis. The pivot movement means that the objective is pivotable around an axis which is perpendicular to the optical axis of the objective. Therefore, any arbitrary positions and observation angles may be assumed in relation to the object. This allows manifold microscopic images, particularly on fixed or stationary objects.

According to a first embodiment of the present invention, the deflection device is equipped with an adjustable reflector which is displaceable along the optical axis of the tube optic. In this case, the adjustment device contains an X drive, using which the objective and the reflector are displaceable jointly along the optical axis of the tube optic. Using this embodiment, an especially simple construction of the deflection device having only one reflector and only one translational drive device is advantageously implemented. If the objective with the reflector is displaced in the direction of the optical axis of the tube optic, the objective may be moved over the object. This procedure is performed primarily in a fixed direction, which is already sufficient for numerous applications, particularly in materials testing. During the movement of the objective with the reflector, worsening of the imaging is advantageously avoided in spite of the change of the distance between objective and barrel object.

According to a further preferred embodiment of the present invention, the deflection device includes two reflectors, specifically an objective reflector and a tube reflector, the adjustment device having a Y drive, using which the objective and the objective reflector are displaceable jointly along a reference direction perpendicular to the optical axis of the tube optic. This design has the advantage over the first embodiment that, particularly when combined with the X drive cited, translations of the objective in both orthogonal directions perpendicular to the optical axis of the objective are made possible. Therefore, the movement range of the objective over the object is expanded. Complete surfaces of the object are accessible to microscopic imaging.

The adjustment device is advantageously equipped with a translational Z drive, using which the objective is displaceable along its optical axis and settable at a specific position. This allows the focusing of the optical system of the imaging device according to the present invention on the particular desired focal plane in the object, which is of special advantage for confocal microscopy in particular.

According to a further preferred embodiment of the present invention, the deflection device is additionally equipped with an intermediate reflector, the objective and intermediate reflectors being displaceable and settable together in such a way that if the tube reflector and/or the objective reflector are displaced with the objective, the length of the beam path from the objective to the tube optic remains constant. Through this measure, the displacement of the image of the objective exit pupil, e.g., on the scanning mirror, may advantageously be completely avoided.

According to further embodiments of the present invention, the objective may be pivoted with the objective reflector around at least one axis perpendicular to the optical axis of the objective. The objective is pivoted using at least one pivot drive. This advantageously allows setting of predetermined observation angles from the objective in relation to the object or focal planes in the object which are defined in an aligned way.

Basically, the translational drives and the pivot drive may be actuated and adjusted independently from one another. However, synchronized operation of all drives is preferred according to the present invention. For synchronized operation, all components which are adjusted in a specific direction are moved simultaneously and using a shared drive.

A subject of the present invention is also a microscope which is equipped with the imaging device described, and an imaging method using the imaging device described, in which the objective is subjected to translational and/or pivot movements and a compensation of the changes of the beam path to the tube optic arising in this case is performed using the deflection device and the adjustment device.

The present invention has the following advantages. The imaging device according to the present invention is usable in all microscope types or microscopy methods which are known per se. There are no restrictions in regard to the type of samples to be investigated, the optical parameters of the imaging system, the type of image recording, or the like. The imaging device according to the present invention allows movement of the objective over a large travel and/or pivot range. The movement may surprisingly be performed without tilting movements, which would interfere with the focusing. Firstly, this allows relatively large, fixed objects (characteristic dimensions in the cm range) to be investigated. Secondly, through the mobility of the objective, a working space may be provided in order to possibly subject the object to additional investigations or processing. During a translational movement of the objective in a plane perpendicular to the optical axis of the objective, the focusing advantageously remains constant. The object may be imaged and/or processed in a focal plane which remains uniform. The deflection device used according to the present invention has a large variability. If multiple reflectors are provided, different folds of the beam path from the objective to the tube optic may be provided, whose geometry is tailored without anything further to the particular given conditions on the measurement construction.

Further advantages and characteristics of the present invention result from the description of the attached figures.

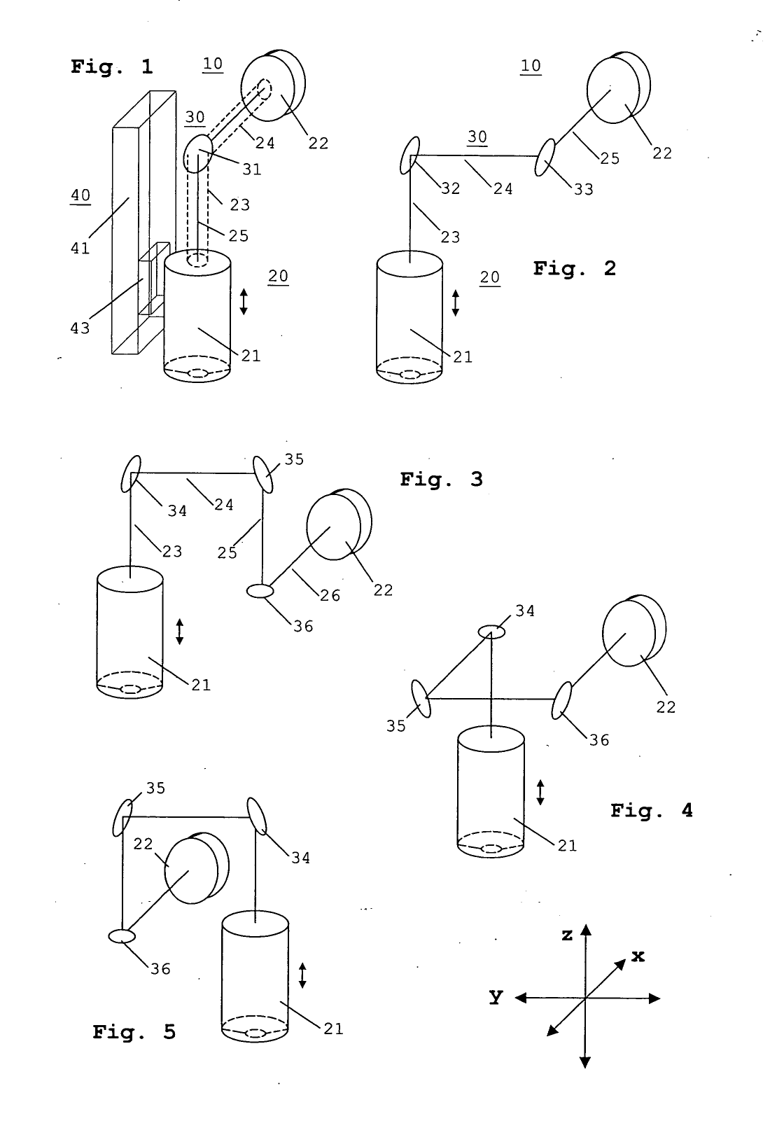

FIGS. 1 through 7 show schematic illustrations of the beam path from the objective to the tube optic in different embodiments of imaging devices according to the present invention,

FIG. 8 shows a schematic illustration of X, Y, and Z drives provided according to the present invention,

FIGS. 9, 10 show further schematic illustrations of the optical system shown in FIG. 2, and

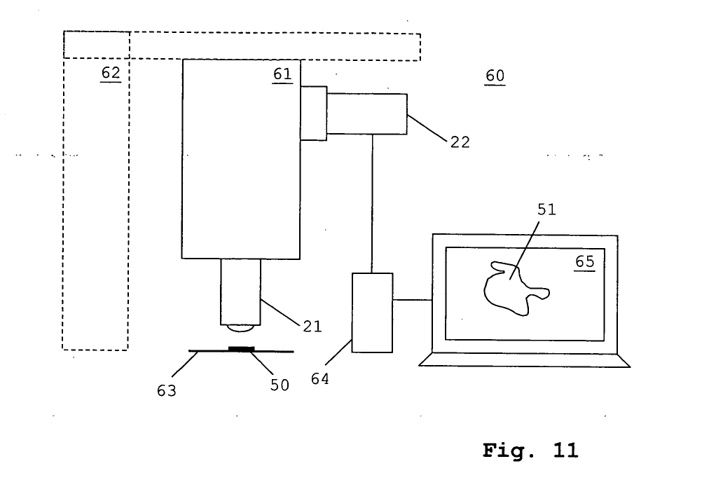

FIG. 11 shows a schematic illustration of a microscope equipped with an imaging device according to the present invention.

The imaging device according to the present invention is preferably provided for optical-microscopic imaging of an object and therefore for use in or with a microscope. There are no restrictions in regard to combination with specific microscope construction types. In the following, the design of the beam path between the objective and the tube optic of an imaging device according to the present invention is therefore primarily discussed. It is further to be noted that the implementation of the present invention is not restricted to the embodiments explained in the following, having up to three reflectors in the beam path of a deflection device used according to the present invention. For specific applications, further folds of the beam path in further spatial directions and/or using further reflectors may be provided. Furthermore, notwithstanding the schematic illustrations, the lengths of the sections of the beam path may be in different ratios in the concrete implementation of the present invention.

An important basic principle of the present invention is that the objective of the imaging device is arranged so it is movable in relation to the tube optic in at least one direction deviating from the direction of the optical axis of the objective. The beam path from the objective to the tube optic runs via at least one reflector of a deflection device. The objective with at least one reflector is moved along the optical axis always in a section of the beam path during translational movements.

The different movement possibilities of the imaging device according to the present invention are illustrated in FIGS. 1 through 10 in relation to the perpendicular coordinate system shown. In this system, the Y direction, as the horizontal direction, and the Z direction, as the vertical direction, lie in the drawing plane of the figures, while the X direction runs perpendicularly to the Y and Z directions. In the following, it is assumed that the tube optic is positioned immovably or stationary with the particular microscope construction in each case. The optical axis of the tube optic runs in the X direction in FIGS. 1 through 8. The reflectors and the objective may execute translational and/or pivot movements which may be directed in different spatial directions.

Generally, the beam path from the objective to the tube optic is deflected at least one time using at least one reflector. At least two sections are formed. The deflection occurs at each reflector by a fixed angle, e.g., 90°. All sections of the beam path run along one of the X, Y, or Z directions to implement translational movements. For pivot movements, the coordinate system is additionally pivotable around the X and/or Y axes.

The reflectors are plane reflectors. They preferably include plane mirrors. For example, dielectric multilayer mirrors of the type LSBM-NIR (available from LINOS photonics) are used. Alternatively, prism reflectors may also be provided as the reflectors. Each reflector is aligned in each case in such a way that the surface normals of the mirror surface form an angle of 45°, for example, to the neighboring sections of the beam path. This alignment is fixed if only translational movements of the objective are provided. For pivot movements of the objective, pivotability of single reflectors is additionally provided.

FIG. 1 shows the simplest case of an imaging device according to the present invention, in which the objective is movable in the X direction in relation to an object (not shown). In addition, movement in the Z direction is provided (see double arrow), which is used for focusing. The focusing in the Z direction is known per se and is therefore not described in greater detail in this and the following embodiments described.

The imaging device 10 according to the present invention shown in FIG. 1 includes an imaging optic 20 having an objective 21 and a tube optic 22, a deflection device 30, which only has one reflector 31 in this embodiment, and an adjustment device 40, which only includes an X drive 41 and a Z drive 43 in the embodiment shown.

Any microscope objective known per se, whose optical parameters are tailored to the particular imaging, measurement, or processing task, may be used as the objective 21. The objective 21 images an image from the object into infinity.

A parallel beam path is generated which is directed onto the tube optic 22 via the reflector 31. The tube optic 22 is used for generating an intermediate image of the object and generating an image of the entrance pupil of the objective 21. Depending on the microscope type, the intermediate image generated by the tube optic 22 is visually observed and/or detected using a detector (e.g., CCD detector), or a scanner mirror (scanning mirror, oscillating mirror) for scanning microscopy is located at the point of imaging of the entrance pupil of the objective 21. The tube optic 22 may be formed, as in a conventional microscope, by a tube lens or alternatively by a construction made of multiple lenses. The tube optic 22 is, for example, of the type Nikon MXA22018. Generally, the parts of the imaging optic 20 may also be formed by mirror optics instead of lens optics.

Using the reflector 31, the parallel beam path from the objective 21 to the tube optic 22 is divided into two sections 23, 24. In FIG. 1, the optical axis 25 of the beam path is shown solid and the outer edge is shown dashed. For reasons of visibility, in the remaining figures only the optical axis along the beam path is shown in each case.

The objective 21 is aligned vertically in the Z direction. Correspondingly, the first section 23 of the beam path runs vertically in the Z direction from the objective 21 to the reflector 31. The reflector 31 is positioned slanted by 45° toward the X direction in relation to the Z direction, so that the second section 24 runs toward the tube optic 22 along its optical axis in the X direction.

In the embodiment shown, the adjustment device 40 includes an X drive 41 and a Z drive 43. According to the present invention, these drives work together with the deflection device 30 in the way described in the following.

The objective 21 is situated so it is movable in a direction deviating from its optical axis. In the embodiment shown in FIG. 1, this movement direction is the X direction. To adjust the beam path onto the tube optic, the reflector 31 of the deflection device is accordingly also displaceable in the X direction. The movement and fixing at a predetermined position is performed using the adjustment device used according to the present invention. Generally, separate adjustment of the reflector 31 and the objective 21 may be performed with subsequent recalibration. However, synchronized adjustment using the shared X drive 41, to which both the reflector 31 and the objective 21 are attached, is preferable. The X drive is, for example, a translationally adjustable table, as is known per se. The X drive 41 has, for example, an adjustment range of 25 mm. The objective 21 is attached to the X drive 41 via the Z drive 43, using which the objective 21 may be focused in any positioned in the Z direction. Alternatively, the objective 21 may also be attached directly to the X drive 41, the entire construction made of imaging optic 20 and deflection device 30 then having to be attached so it is displaceable in the Z direction for focusing.

For microscopic imaging of an object, the objective 21 is focused on the focal plane of interest of the object. In order to image different regions of the object, the objective 21 may be moved together with the reflector 31 in the X direction, without the optical imaging with the tube lens 22 being restricted.

An expansion to two translational directions, specifically the X and Y directions, is illustrated in FIG. 2. For reasons of visibility, the adjustment device 40 is not shown in FIG. 2. Further characteristics of the adjustment device 40 are described below with reference to FIG. 8. The embodiment of the imaging device 10 according to the present invention shown in FIG. 2 again includes the imaging optic 20 having the objective 21 and the tube optic 22 and a deflection device 30, which has two reflectors in this case. The reflectors are referred to as the objective reflector 31 and the tube reflector 33. The beam path from the objective 21 to the tube optic 22 is divided by the objective and tube reflectors 31, 32 into three sections 23, 24, and 25. The optical axis of the section 23 is coincident with the optical axis of the objective 21. The optical axis of the section 25 is coincident with the optical axis of the tube optic 22. The central section 24 runs perpendicularly to the other two sections in the Y direction. The reflectors 31, 32 are correspondingly aligned in relation to the adjoining sections to form 45° angles to each of the surface normals.

The deflection and adjustment devices used according to the present invention work together as follows to generate translational movements of the objective 21 in the X and/or Y directions. In the following explanation, reference is also made to the table specified below, in which the degrees of freedom of the individual components of the imaging device according to the present invention are listed. To set the beam path on the tube optic 22 in the event of a X translation of the objective 21, the tube reflector 33 is displaceable in the X direction. No adjustability of the tube reflector 33 is provided in the Y and Z direction, in order to maintain the alignment to the fixed tube optic 22. The adjustment of the tube reflector 32 is performed analogously to the adjustment of the reflector 31 in FIG. 1.

To set the beam path on the tube reflector 33 and therefore on the tube optic 22 in the event of translation of the objective 21 in the Y direction, the objective reflector 33 is displaceable in the Y direction. This displacement along the optical axis of the beam path in section 24 is performed analogously to the above displacements in the X direction. The components shown in FIG. 2 have the following degrees of freedom, in accordance with the functional interaction. The objective 21 is displaceable in all three spatial directions. The objective reflector 32 has degrees of freedom for displacement in the X and Y directions. The tube reflector 33 is displaceable exclusively in the X direction (see table). The drives are preferably operated synchronously using an adjustment device, an example of which is shown in FIG. 8.

Through joint displacement of the objective 21 with the objective reflector 32 and the tube reflector 33 by equal path lengths in the X direction, the objective 21 is correspondingly moved over the object in the X direction while maintaining the optical imaging. The translation in the Y direction results through joint displacement of the objective 21 and the objective reflector 32 by equal path lengths in the Y direction. The movement path in the X and Y directions is up to 25 mm in each case, for example.

In the embodiments shown in FIGS. 1 and 2, the total length of the beam path from the objective 21 to the tube optic 22 is changed in the event of displacement of the objective 21. For example, the beam path is shortened by shortening the section 25 in the event of displacement of the object 21 in the X direction toward the tube optic 22. In the opposite direction, the length of the section 25 increases. Depending on the application, these changes are significantly larger than the adjustments in the Z direction for focusing the objective 21. Although the objective 21 is laid out in principle for a parallel beam path, changes of the distance between objective 21 and tube optic 22 may only be tolerated within specific limits, since the position of the pupil image along the optical axis is displaced, for example, which may be disadvantageous in confocal microscopes. In order to counteract this problem, a deflection device may be provided according to the present invention, using which the total length of the beam path is kept constant. This is illustrated in FIGS. 3 through 5.

The deflection device used according to the present invention includes three reflectors as shown in FIG. 3, which are referred to in the following as the objective reflector 34, the intermediate reflector 35, and the tube reflector 36.

The reflectors 34 through 36 cover a beam path folded analogously to the principles explained above, having four sections 23 through 26. According to the functional principle and the overview illustration in the table (see below), the objective 21 has degrees of freedom in all spatial directions. The objective reflector 34 is also adjustable in all three spatial directions. The intermediate reflector 35 is adjustable in the X and Z directions, while the tube reflector 36 only has a degree of freedom in the X direction. For translation of the objective 21 in the X direction, all components 21, 34, 35, and 36 are moved in the X direction by equal path lengths. This is preferably performed using a shared X drive (not shown). For translation in the Y direction, the components 21 and 34 are correspondingly moved by equal path lengths, which is again preferably performed using a shared Y drive. In the event of X and/or Y translations, the lengths of the sections 24 and 26 are accordingly changed. In order to compensate for these changes and keep the total length of the beam path constant, adjustment of the reflectors 34 and 35 in the Z direction is provided. For this purpose, the adjustment device has a Z drive having a first partial drive for focusing of the objective 21 and a second partial drive for shared compensational movement of the reflectors 34 and 35. The second partial drive is controlled in such a way that in the event of translation in the X or Y direction by a specific path length, a displacement of the reflectors 34 and 35 in the Z direction corresponding to half of the path length occurs. Since this compensational movement has a doubled effect on the two sections 23 and 25, the corresponding translation is compensated for.

FIGS. 4 and 5 show other folding variations of a deflection device, used according to the present invention, having three reflectors, which are set up for translation of the objective 21 and for length compensation of the beam path, the degrees of freedom illustrated in the table being provided.

| FIG. 1 | | | FIG. 2 | | | FIG. 3 | | | | FIG. 4 | | | | FIG. 5 | | | |
|---|---|---|---|---|---|---|---|---|---|---|---|---|---|---|---|---|---|
| | 21 | 31 | 21 | 32 | 33 | 21 | 34 | 35 | 36 | 21 | 34 | 35 | 36 | 21 | 34 | 35 | 36 |
| X | ▪ | ▪ | ▪ | ▪ | ▪ | ▪ | ▪ | ▪ | ▪ | ▪ | ▪ | ▪ | ▪ | ▪ | ▪ | ▪ | ▪ |
| Y | | | ▪ | ▪ | | ▪ | ▪ | | | ▪ | ▪ | ▪ | | ▪ | ▪ | | |
| Z | ▪ | | ▪ | | | ▪ | ▪ | ▪ | | ▪ | | | | ▪ | ▪ | ▪ | |

The length compensations are each performed correspondingly in the X direction or in the Z direction as shown in FIGS. 4 and 5. Analogously to the principles shown in FIGS. 3 through 5, other folds of the beam path from the objective 21 to the tube optic 22 may also be performed.

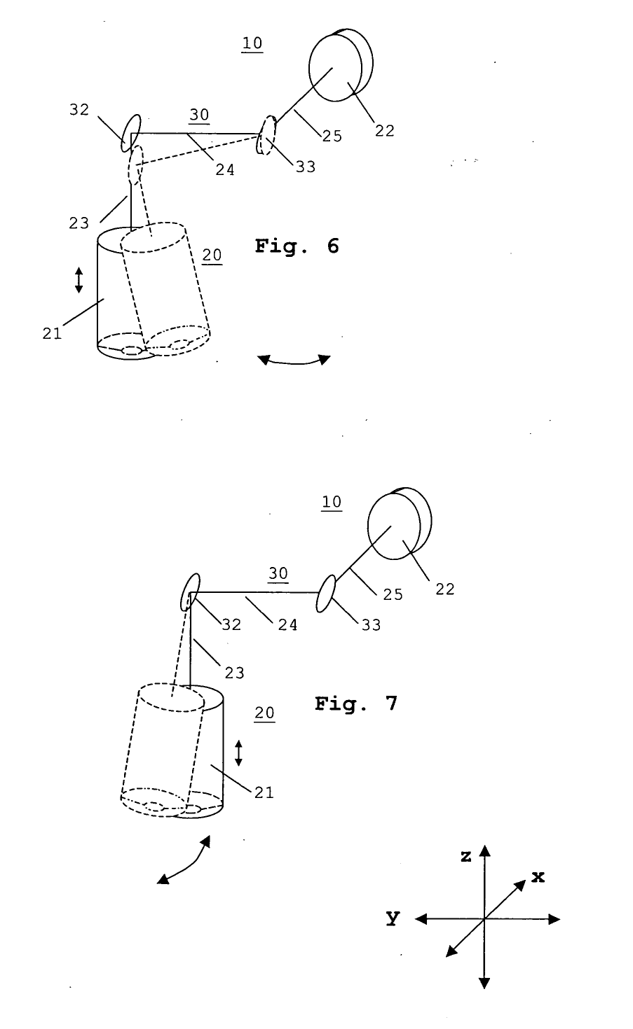

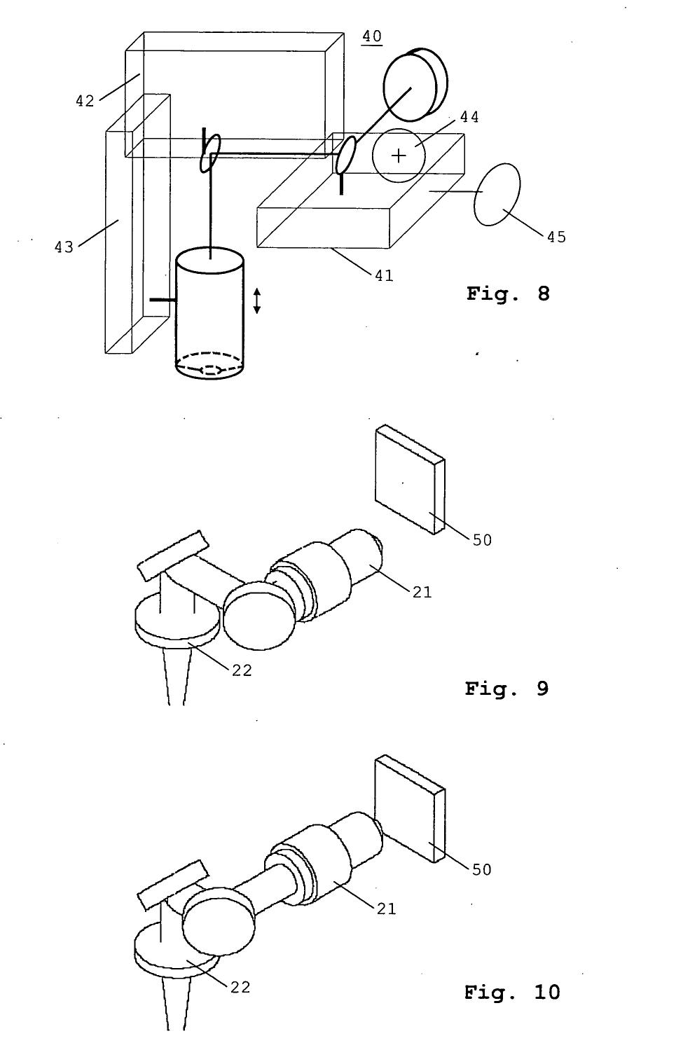

FIGS. 6 and 7 show further embodiments of the present invention, in which pivoting of the objective 21 with the objective reflector 32 around at least one axis perpendicular to the optical axis of the objective is provided. The pivoting of the objective 21 is preferably combined with the translations described, but may also be implemented alone.

The optical axis of the initially unpivoted objective 21 is aligned vertically in the Z direction. The focal plane is parallel to the X-Y plane. In order to tilt the focal plane in relation to the X-Y plane, the objective 21 is pivoted with the objective reflector 32. The pivot axis is coincident with the optical axis of the imaging optic 22 along the section 25 (FIG. 6) or along the section 24 (FIG. 7). Both pivot movements may also be combined, so that an effective pivot axis in a plane parallel to the X-Y plane results. A typical pivot angle in the range up to 360° results for FIG. 6. The pivot movement and setting in the pivoted position is performed using at least one pivot drive (not shown in FIGS. 6 and 7). In each state, the right angles between the sections 23, 24, and 25 of the beam path are maintained.

In FIG. 8, the components of the drive device 40 used according to the present invention are schematically illustrated on the example of the embodiment shown in FIG. 2. In other embodiments, the drive device is adapted appropriately to implement the particular translational and/or pivot movements. The drive device 40 includes an X drive 41, a Y drive 42, a Z drive 43, a YZ pivot drive 44, and an XZ pivot drive 45.

For synchronized translation and/or pivoting, using the X drive 41, besides the optical parts, the Y and Z drives 42, 43 are also actuated and the Z drive 43 is also actuated using the Y drive 42. For pivoting, the X drive 41 is attached to the YZ pivot drive 44, and this drive is attached to the XZ pivot drive 45 (or vice versa). The X, Y, and Z drives are preferably linear actuating drives, such as typical linear actuator tables. For example, linear actuator tables of the type micromanipulator MP285 (3Z version, Sutter Instruments) are used. The schematically illustrated YZ and XZ pivot drives 44, 45 are formed by rotary tables, for example, to which the X drive is attached via a support tube.

In the embodiment shown in FIGS. 3 through 5, the Z drive includes two partial drives, which are set up for focusing the objective along the optical axis and for displacing the length-compensating branch of the beam path, respectively. They are both attached to the Y drive 42 and are actuatable independently of one another.

In FIGS. 9 and 10, it is illustrated that the implementation of the present invention is not restricted to the embodiments described above having a vertically aligned objective 21. The object (sample) 50 may also be observed horizontally and the object image may be deflected to a vertically aligned tube optic 22. FIG. 9 shows the objective 21 in a state pulled back from the sample 50, in which a work space for further measurement or processing steps is provided.

A microscope 60 according to the present invention, which is equipped with the imaging device described above, is illustrated in FIG. 11. The microscope 60 particularly includes a housing and/or carrier 61, to which the objective 21, the tube optic 22, and the deflection device (not shown) are attached, a frame 62, a sample holder 63, a detector device 64, and a control and analysis device 65. The adjustment device described above is not shown. It is attached to the carrier 61 or frame 62 using the X drive or one of the pivot drives. The design and position of the detector device 64 are only illustrated schematically. It includes, for example, a camera or a scanning mechanism for scanning microscopy. The control and analysis device 65 is formed by a personal computer having a display screen, for example. The current operating state of the microscope and/or the enlarged image of a section of the sample, such as a cell organelle 51, are displayed on the display screen. The schematically illustrated sample holder 63 may be set up, depending on the application, for fixed attachment of the sample 50 or even additional displacement using a typical sample table.

The microscope 60 may furthermore be equipped with additional devices, such as a calibration laser or measurement devices. Using the calibration laser, the imaging device according to the present invention is recalibrated if necessary before beginning operation or after adjustment steps, for example.

The features of the present invention disclosed in the preceding description, the claims, and the figures may be significant in their various designs both alone and in any combination for the implementation of the present invention.

1-12. (Cancelled)

13. An imaging device for microscopic imaging of an object having:
an objective, which is set up to generate an object image in infinity, and
a fixed tube optic, which is set up to generate an intermediate image from the object image, wherein the objective is movable in relation to the tube optic in at least one reference direction which deviates from the alignment of the optical axis of the objective,
a deflection device, having at least one adjustable reflector, which directs the beam path from the objective onto the tube optic in any position of the objective in such a way that it runs perpendicularly to the tube optic and parallel to its optical axis, and
an adjustment device using which the objective and the at least one reflector are movable.

14. The imaging device according to claim 13, wherein the adjustment device has an X drive, using which the objective and the at least one reflector are displaceable jointly along the optical axis of the tube optic.

15. The imaging device according to claim 13 or 14, wherein an objective reflector and a tube reflector are provided and the adjustment device has a Y drive, using which the objective and the objective reflector are displaceable along a reference direction perpendicular to the optical axis of the tube optic.

16. The imaging device according to claim 15, wherein the Y drive is displaceable using the X drive.

17. The imaging device according to claim 13 or 14, wherein the adjustment device has a Z drive, using which the objective is displaceable along its optical axis.

18. The imaging device according to claim 17, wherein the Z drive is displaceable using the Y drive and/or the X drive.

19. The imaging device according to claim 13, wherein an objective reflector, a tube reflector, and an intermediate reflector are provided, the objective reflector and the intermediate reflector being jointly displaceable in such a way that in the event of displacement of the tube reflector, the length of the beam path from the objective to the tube optic remains constant.

20. The imaging device according to claim 19, wherein the adjustment device has a Z drive, using which the objective is displaceable along its optical axis.

21. The imaging device according to claim 20, wherein the Z drive has a first partial drive, using which the objective is displaceable, and a second partial drive, using which the objective and intermediate reflectors are displaceable.

22. The imaging device according to claim 13, wherein the adjustment device has at least one pivot drive, using which the objective and the reflectors are pivotable jointly around the optical axis of the tube optic and/or around an axis perpendicular to the optical axes of the objective and the tube optic.

23. The imaging device according to claim 13, wherein the tube optic is part of an ocular for visual observation of the intermediate image, a detector device for detection of the intermediate image, and/or a scanning device having a scanner mirror.

24. A microscope, which is equipped with an imaging device according to claim 13.

25. A method for microscopic imaging of an object, in which the object is imaged at infinity using an objective and an intermediate image of the object is generated using a tube optic, comprising the steps of:
moving the objective in relation to the tube optic in at least one reference direction which deviates from the alignment of the optical axis of the objective, and
directing the beam path from the objective onto the tube optic using a deflection device having at least one adjustable reflector in such a way that the optical axes of the objective and the tube optic are coincident in any position of the objective.
